(19) United States
(12) Patent Application Publication
(10) Pub. No.: US 2023/0147964 A1
(43) Pub. Date: May 11, 2023

(54) WEED REMOVAL TOOL

(71) Applicant: Rhonda McCray, Davis, CA (US)

(72) Inventor: Rhonda McCray, Davis, CA (US)

(21) Appl. No.: 17/519,883

(22) Filed: Nov. 5, 2021

(51) Int. Cl. A01B 1/16

(52) U.S. Cl. CPC A01B 1/16

(57) ABSTRACT

A weed removal tool and a method of using the weed removal tool to remove a weed from the ground are disclosed. The weed removal tool includes a head mounted on an end of a handle. The head has a claw extending laterally from the handle to a claw tip. A pair of prongs are separated by a slot at the claw tip. The slot receives a stem of a weed to engage the claw to the stem at or near a base of the stem. The handle is pivoted about the head to cause the claw to grip the stem and to produce leverage that pulls a root of the weed from the ground. Other embodiments are also described and claimed.

### FIELD

The present disclosure relates to gardening tools. More particularly, the present disclosure relates to weed removal tools used to remove weeds from the ground.

### BACKGROUND INFORMATION

Weeds are undesired plants that grow in a garden or field of desired plants. Weeds can grow vigorously and crowd or choke out the desired plants. When this happens, a gardener or farmer may attempt to remove the weeds. For example, the gardener may pull the weed by hand or attempt to use a weed removal tool, such as a hoe, to chop or dig the weed out of the ground.

### SUMMARY

Removing weeds using existing weed removal tools can be physically strenuous and ineffective. For example, generating the force required to chop a weed requires substantial physical strength and, in the case of large gardens with many weeds, endurance. Furthermore, chopping the weed may remove a stem of the weed but leave the root of the weed intact in the soil. This is especially the case in dry soil in which the soil strongly retains the root. The remaining root can allow the weed to regrow, and thus, existing weed removal tools only provide a temporary weed abatement solution. Accordingly, there is a need for a weed removal tool that can remove the entire weed, including the root, from moist or dry soils, and which require minimal physical exertion to use.

The present invention provides a weed removal tool. In an embodiment, the weed removal tool includes a head mounted on an end of a handle. The head includes one or more claws that extends laterally to a claw tip. For example, the head can include claws suited to pulling differently sized weeds on each side of the handle. Each claw can extend laterally and proximally from a distal end of the handle.

The claw(s) of the tool head are configured to engage a weed. Each claw can include a slot separating a pair of prongs. The slot can receive a stem of the weed. For example, the slot can include a v-shaped notch between the pair of prongs to receive the weed stem. The prongs may include a gripping surface, e.g., serrations or a beveled surface, to grip the weed stem. Accordingly, when a user strikes at the weed, the stem can be received in the slot and the claw engages the stem. In a method of using the weed removal tool, the handle may then be pivoted about the head, e.g., rocked about the head on the ground, to uproot the weed from the ground.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 is a perspective view of a weed removal tool, in accordance with an embodiment.

FIG. 2 is a side view of a weed removal tool, in accordance with an embodiment.

FIG. 3 is a side view of a head of a weed removal tool, in accordance with an embodiment.

FIG. 4 is a distal end view of a weed removal tool, in accordance with an embodiment.

FIG. 5 is a proximal end view of a weed removal tool, in accordance with an embodiment.

FIGS. 6-7 are pictorial views of operations of a method of removing a weed from the ground using a weed removal tool, in accordance with an embodiment.

### DETAILED DESCRIPTION

Embodiments describe a weed removal tool and a method of using the weed removal tool to remove a weed from the ground. The weed removal tool can be used to pull a weed. The weed removal tool may be used, however, to remove any plant, e.g., to thin a crop. Thus, reference to the tool as being for weed removal is not limiting.

In various embodiments, description is made with reference to the figures. However, certain embodiments may be practiced without one or more of these specific details, or in combination with other known methods and configurations. In the following description, numerous specific details are set forth, such as specific configurations, dimensions, and processes, in order to provide a thorough understanding of the embodiments. In other instances, well-known processes and manufacturing techniques have not been described in particular detail in order to not unnecessarily obscure the description. Reference throughout this specification to “one embodiment,” “an embodiment,” or the like, means that a particular feature, structure, configuration, or characteristic described is included in at least one embodiment. Thus, the appearance of the phrase “one embodiment,” “an embodiment,” or the like, in various places throughout this specification are not necessarily referring to the same embodiment. Furthermore, the particular features, structures, configurations, or characteristics may be combined in any suitable manner in one or more embodiments.

The use of relative terms throughout the description may denote a relative position or direction. For example, “distal” may indicate a first direction relative to a reference point. Similarly, “proximal” may indicate a second direction opposite to the first direction. Such terms are provided to establish relative frames of reference, however, and are not intended to limit the use or orientation of a weed removal tool to a specific configuration described in the various embodiments below.

In an aspect, a weed removal tool is provided to remove a weed from the ground. The weed removal tool includes a tool head mounted on a handle. For example, the tool head can be a metal head having one or more fork-like claws. In an embodiment, the head includes two claws, one on each side of the handle, to engage differently sized weed stems. More particularly, a user can hold the handle and strike once at a base of a weed stem. The user may then pull and/or rock the handle to dislodge and remove the weed roots from the ground. The rocking motion uses leverage, and thus, requires minimal strength. Furthermore, the motion dislodges the weed roots from all soil types, whether the soil is dry or wet. Accordingly, the weed removal tool provides an easy to use weed control solution that pulls weeds out by their roots such that the weeds cannot grow back and a garden or flower bed remains free of weeds for long periods of time.

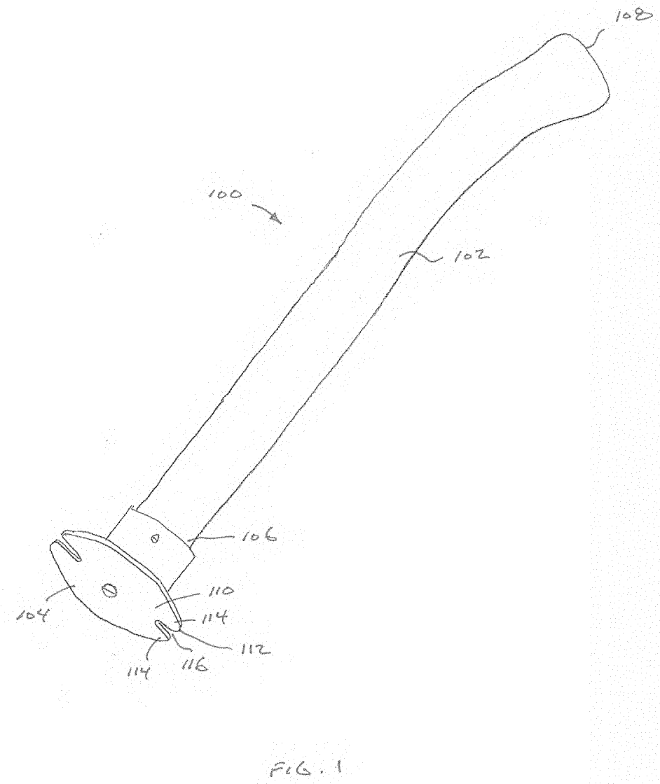

Referring to FIG. 1, a perspective view of a weed removal tool is shown in accordance with an embodiment. A weed removal tool 100 can be used to pull a weed out of the ground. The weed removal tool 100 can include a handle 102 that a user can hold to strike at the weed. More particularly, the user can engage a head 104 of the weed removal tool 100 to a stem of the weed, as described below, and then pivot the handle 102 to dislodge the weed from the earth.

In an embodiment, the handle 102 extends longitudinally and distally to a handle end 106. More particularly, the handle 102 can extend along a longitudinal axis from the handle end 106 at a distal end of the handle 102 to a second handle end 108 at a proximal end of the handle 102. The handle 102 may include one or more curved sections between the ends. In an embodiment, a curved section may be nearer to the proximal end of the handle 102 than to the distal handle end 106. The curved handle 102 can provide a comfortable grip for the user to hold while weeding a garden.

The weed removal tool 100 includes the head 104 mounted on the handle end 106. In an embodiment, the head 104 includes one or more claws 110 extending laterally outward to respective claw tips 112. For example, a claw 110 can extend laterally to a claw tip 112 on a first side of the handle 102, and one or more additional claws 110 can extend laterally from the handle 102 at locations that are radially offset from the claw 110 relative to a longitudinal axis of the handle 102.

Each claw 110 of the head 104 can have respective prongs 114 to engage the weed stem. More particularly, the claw 110 includes a slot 116 separating a first set or pair of prongs 114 at the claw tip 112. When the user engages the claw 110 of the head 104 to the stem of the weed, the stem is received within the slot 116 of the claw 110. Accordingly, the prongs 114 can grip the stem, which is received in the slot 116, to pull the weed from the ground when the user pulls or pivots the handle 102.

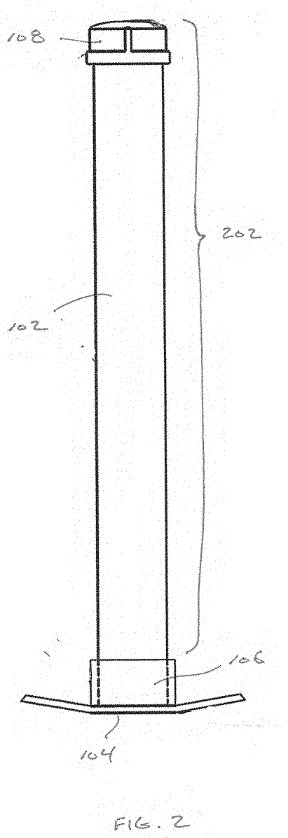

Referring to FIG. 2, a side view of a weed removal tool is shown in accordance with an embodiment. The handle 102 can have a handle length 202 between the handle end 106 at the distal end of the handle 102, and the second handle end 108 at the proximal end of the handle 102. The length 202 can be sized to facilitate the generation of leverage when pulling the weed out of the ground. In an embodiment, the length 202 of the handle 102 is greater than 12 inches, e.g., at least 18 inches. In an embodiment, the handle length 202 is 24 inches or more. It will be appreciated from the description below that a longer handle 102 can generate more leverage to uproot the weed with less force input (less physical exertion).

As shown in FIG. 2, the handle 102 may be straight along its length 202. More particularly, although the handle 102 may be curved (FIG. 1), in some embodiments the handle 102 is straight between the handle end 106 and the second handle end 108. Accordingly, the handle 102 may include a rod, pipe, dowel, or other readily available structure that the weed removal tool head 104 can be attached to and/or mounted on.

Referring to FIG. 3, a side view of a head of a weed removal tool is shown in accordance with an embodiment. The weed removal tool head 104 can include a collar 302 extending longitudinally and distally to a collar end 304. The collar 302 may, for example, have a tubular structure that extends from a proximal tube end to a distal tube end at the collar end 304. The tubular structure can have an annular cross-sectional profile (FIG. 5). Accordingly, the handle 102, and more particularly the handle end 106, can be received within the collar 302. The head 104 may then be fastened to the handle 102 using a screw, an adhesive, a wedge inserted into the handle end 106, or by other fastening techniques.

In an embodiment, the head 104 is denser than the handle 102. For example, the head 104 may be fabricated from metal, and the handle 102 may be fabricated from wood. In any case, a weight of the head 104 can cause a center of gravity of the weed removal tool 100 to be nearer to a distal end of the handle 102 than to a proximal end of the handle 102. The weighting of the tool can focus the force input at a base of the weed stem when the head 104 strikes the stem, and thus, facilitate engagement of the stem with the head 104.

As described above, the head 104 can have two or more claws 110 extending laterally outward from the handle 102. In an embodiment, the claw 110 extends laterally outward from the handle 102, e.g., from the collar 302 mounted on the handle 102, to the claw tip 112. Similarly, a second claw 306 can extend laterally from the handle 102, e.g., from the collar 302 mounted on the handle 102, to a second claw tip 112. The second claw 306 can extend laterally from the handle 102 opposite to the claw 110. Accordingly, the weed removal tool 100 can have several claws 110 on opposite sides of the handle 102. As described below, each of the claws may be suited to pulling differently sized weeds. For example, the claw 110 may be used to pull weeds having thin stems, and the second claw 306 may be used to pull weeds having thick stems.

Each of the claws 110 may extend laterally at a slight angle to a transverse plane that is orthogonal to the handle axis. More particularly, the claw 110 can extend laterally and proximally from the handle end 106 to the claw tip 112. As such, the claw tip 112 may be proximally located relative to the collar end 304. Although the claw 110 is shown as extending straight from the collar end 304 to the claw tip 112, it will be appreciated that the claw 110 may be curved in the proximal direction. The lateral and proximal extension of the claw 110 can provide several benefits. First, the oblique angle of the claw 110 to the handle end 106 provides for a better angle of attack when the user strikes at the stem of the weed. Second, the curvilinear shape of the head claws allows the tool to be rocked more smoothly about the head 104 when the user applies leverage at the handle 102 to pull the weed out of the ground.

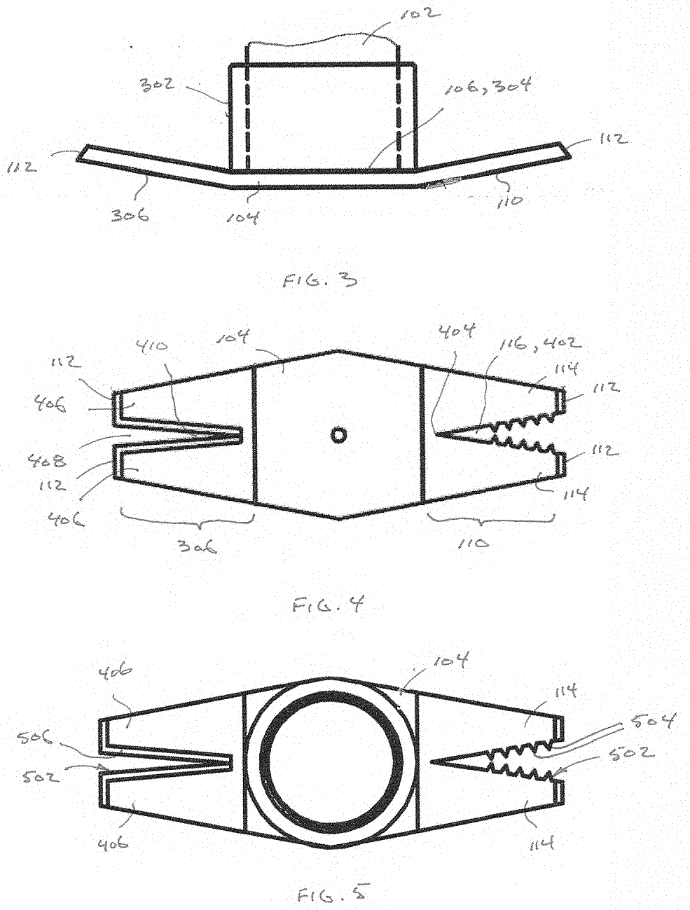

Referring to FIG. 4, a distal end view of a weed removal tool is shown in accordance with an embodiment. Each side of the claw head 104 can include a set of prongs 114. The claw 110 on a first side of the handle 102 includes a pair of prongs 114 separated by the slot 116. For example, the slot 116 can include a v-shaped notch 402 extending laterally inward from the claw tip 112 toward the handle 102. The v-shaped notch 402 between the pair of prongs 114 can have a width that narrows laterally inward in an inward radial direction, and terminates at a notch end 404. Like the claw 110, the second claw 306 can include a second pair of prongs. The second pair prongs includes a pair of second prongs 406 separated by a second slot 408. The second slot 408 can include a v-shaped notch 410 between the second prongs 406.

In an embodiment, the slot of each claw of the head 104 is sized differently. The size of the slot can correspond to a size of weed that the respective claw is suited to pull. For example, the second slot 408 of the second claw 306 may be wider than the slot 116 of the first claw 110. By way of example, a width of the slot 116 between the first pair of prongs 114 at the claw tip 112 may be 0.375 inch, and a width of the second slot 408 between the second pair of prongs 406 at the claw tip 112 may be 0.75 inch. Accordingly, the second claw 306 may be better suited to pulling weeds having thick stems, and the first claw 110 may be better suited to pulling weeds having thinner stems.

Referring to FIG. 5, a proximal end view of a weed removal tool is shown in accordance with an embodiment. The claw(s) of the head 104 can include a gripping surface 502 in the respective slot. The gripping surface 502 can provide a feature that engages and grips the weed stem. The gripping surface 502 can be located along an edge of one or more of the prongs 114. For example, the gripping surface 502 can be a roughened surface, as compared to adjacent surfaces of the prongs 114, along an edge facing inward toward the slot.

In an embodiment, the gripping surface 502 includes one or more serrations 504. The serrations 504 can include a tooth, or several teeth, extending inward from the prong into the slot. The serration(s) 504 may be on each prong of the claw such that the teeth extend toward each other and coordinate to grip a weed stem.

The gripping surface 502 may include a beveled surface along an edge of the prongs. A bevel 506 can extend along the edge, such that the inward surface of the bevel (the portion nearest to the slot) is thinner than an outward surface of the bevel (the portion furthest from the slot). The bevel 506 may create a wedge that scrapes and digs into the weed stem. Accordingly, the bevel 506 can grip the weed stem even though it may not be rougher than the region around the bevel 506, in contrast to the serration 504.

Referring to FIG. 6, a pictorial view of an operation of a method of removing a weed from the ground using a weed removal tool is shown in accordance with an embodiment. The method of removing the weed 602 can begin by gripping the handle 102 of the weed removal tool 100 and striking at the weed 602. More particularly, the user can engage the claw 110 of the head 104 of the weed removal tool 100 to a stem 604 of the weed 602. When the stem 604 is received within the slot 116 of the claw 110, the head 104 can be adjacent to the ground (e.g., soil) at a base 606 of the stem 604.

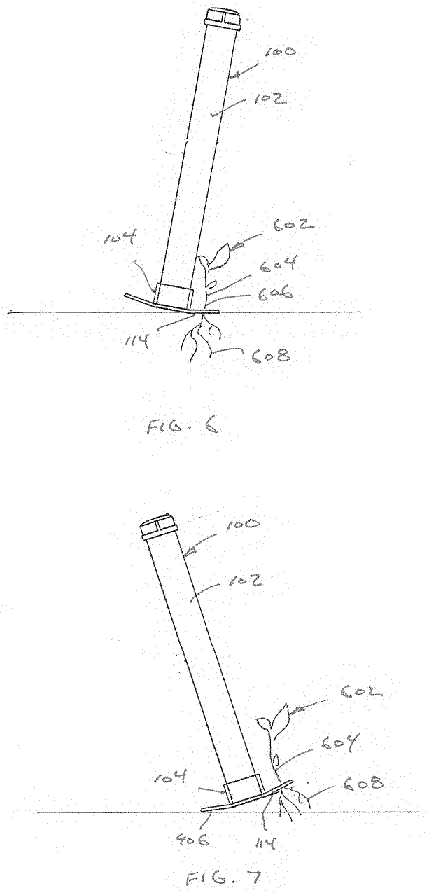

Referring to FIG. 7, a pictorial view of an operation of a method of removing a weed from the ground using a weed removal tool is shown in accordance with an embodiment. After engaging the claw 110 to the weed 602, the prongs 114, e.g., the gripping surface 502 of the prongs 114, can grip the weed stem 604. Accordingly, the weed removal tool 100 can become fixed to the weed 602 such that movement of the weed removal tool 100 causes movement of the weed stem 604. Such movement could include pulling the weed removal tool 100 upward, e.g., pulling up on the handle 102. In moist soil, the upward pull may be sufficient to uproot the weed 602, i.e., to pull a root 608 of the weed 602 from the ground.

As shown in FIG. 7, the movement of the weed removal tool 100 can include pivoting the handle 102 of the weed removal tool 100 about the head 104. As the handle 102 pivots about the head 104, the head 104 can roll over the ground from the prongs 114 on a first side of the handle 102 to a portion, e.g., the second prongs 406, on a second side of the handle 102. The rocking motion causes the prongs 114 engaged to the weed stem 604 to lift, and the handle 102 applies leverage that gradually applies high loading to the weed stem 604. Accordingly, even under dry soil conditions, the claw 110 can pull the root 608 out of the soil when the handle 102 pivots about the head 104.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A weed removal tool, comprising:
a handle extending longitudinally and distally to a handle end; and
a head mounted on the handle end, wherein the head includes a claw extending laterally to a claw tip, and wherein the claw includes a slot separating a pair of prongs at the claw tip to receive a stem of a weed.

2. The weed removal tool of claim 1, wherein the pair of prongs have a gripping surface in the slot.

3. The weed removal tool of claim 2, wherein the gripping surface includes one or more serrations.

4. The weed removal tool of claim 1, wherein the slot includes a v-shaped notch between the pair of prongs.

5. The weed removal tool of claim 1, wherein the claw extends laterally and proximally from the handle end to the claw tip.

6. The weed removal tool of claim 1, wherein the head includes a second claw extending laterally from the handle opposite to the claw, and wherein the second claw includes a second pair of prongs separated by a second slot.

7. The weed removal tool of claim 6, wherein the second slot is wider than the slot.

8. The weed removal tool of claim 1, wherein the handle has a length of at least eighteen inches.

9. The weed removal tool of claim 1, wherein the head is denser than the handle.

10. A weed removal tool head, comprising:
a collar extending longitudinally and distally to a collar end; and
a claw having a pair of prongs extending laterally between the collar end and a claw tip, wherein the pair of prongs are separated by a slot at the claw tip to receive a stem of a weed.

11. The weed removal tool head of claim 10, wherein the pair of prongs have a gripping surface in the slot.

12. The weed removal tool head of claim 11, wherein the gripping surface includes one or more serrations.

13. The weed removal tool head of claim 10, wherein the slot includes a v-shaped notch between the pair of prongs.

14. The weed removal tool head of claim 10, wherein the claw extends laterally and proximally from the collar end to the claw tip.

15. The weed removal tool head of claim 10 further comprising a second claw extending laterally from the collar end opposite to the claw, and wherein the second claw includes a second pair of prongs separated by a second slot.

16. The weed removal tool head of claim 15, wherein the second slot is wider than the slot.

17. A method, comprising:
engaging a claw of a head of a weed removal tool to a stem of a weed such that the head is adjacent to the ground at a base of the stem and the stem is received within a slot of the claw; and
pivoting a handle of the weed removal tool about the head, wherein the head is mounted at an end of the handle such that the claw pulls a root of the weed out of the ground when the handle pivots about the head.

18. The method of claim 17, wherein the handle extends longitudinally and distally to a handle end, wherein the head is mounted on the handle end, wherein the claw has a pair of prongs extending laterally to a claw tip, and wherein the pair of prongs are separated by the slot at the claw tip.

19. The method of claim 17, wherein the pair of prongs have a gripping surface in the slot.

20. The method of claim 19, wherein the gripping surface includes one or more serrations.
